(19) United States
(12) Patent Application Publication
(10) Pub. No.: US 2006/0214646 A1
(43) Pub. Date: Sep. 28, 2006

(54) Time sharing inductor in DC-DC converter

(76) Inventor: Yihe Huang, Palo Alto, CA (US)

Correspondence Address: SAWYER LAW GROUP LLP, P O BOX 51418, PALO ALTO, CA, 94303, US

(21) Appl. No.: 11/089,830

(22) Filed: Mar. 24, 2005

(51) Int. Cl. G05F 1/00

(52) U.S. Cl. 323/222

(57) ABSTRACT

A DC-DC converter is disclosed. The converter comprises a voltage source; a single inductor coupled to the voltage source; and a first switch coupled to the single inductor and the voltage source. The converter further comprises a plurality of switch capacitor mechanisms, each of the plurality of switch capacitor mechanisms coupled to the voltage source, first switch and inductor. There are two phases of operation of the converter. During first phase the first switch is on and the plurality of capacitor switch mechanisms are inactive to charge the inductor. During a second phase one of the capacitor switch mechanisms is active causing the capacitor switch mechanism to act as a power supply. Each of the capacitor switch mechanisms can be alternately active to provide a plurality of voltage levels. A scheme in accordance with the present invention allows for a converter which provides multiple voltages that share a single inductor and therefore, significantly minimizes cost.

### FIELD OF THE INVENTION

The present invention relates generally to DC-DC converters.

### BACKGROUND OF THE INVENTION

In many applications, an DC-DC converter must supply power of multiple voltage levels. FIG. 1 illustrates a typical boost DC-DC converter 10. The boost converter 10 is utilized to provide a small to medium power supply. In this conventional design, one inductor 12 is needed for each power supply output. Accordingly, to provide multiple voltage levels utilizing a conventional DC-DC converter, multiple inductors must be utilized. These additional inductors greatly increase the cost of the converter 10.

Accordingly, what is needed is a system and method for reducing the number of inductors utilized in a DC-DC converter when multiple power supplies are needed and therefore significantly reducing cost. The present invention addresses such a need.

### SUMMARY OF THE INVENTION

A DC-DC converter is disclosed. The converter comprises a voltage source; a single inductor coupled to the voltage source; and a first switch coupled to the single inductor and the voltage source. The converter further comprises a plurality of switch capacitor mechanisms, each of the plurality of switch capacitor mechanisms coupled to the voltage source, first switch and inductor.

There are two phases of operation of the converter. During first phase the first switch is on and the plurality of capacitor switch mechanisms are inactive to charge the inductor. During a second phase one of the capacitor/load mechanisms is active causing the capacitor switch mechanism to act as a power supply. Each of the capacitor switch mechanisms can be alternately active to provide a plurality of voltage levels. A scheme in accordance with the present invention allows for a converter which provides multiple voltages that share a single inductor and therefore, significantly minimizes cost.

### BRIEF DESCRIPTION OF THE DRAWINGS

FIG. 1 illustrates a typical boost converter.

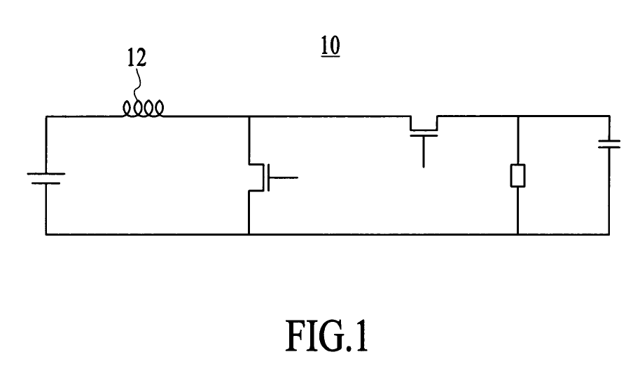

FIG. 2 is an example multiple output DC-DC converter using a single inductor.

FIG. 3 shows an example operation sequence of the DC-DC converter.

### DETAILED DESCRIPTION

The present invention relates generally to DC-DC converters. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

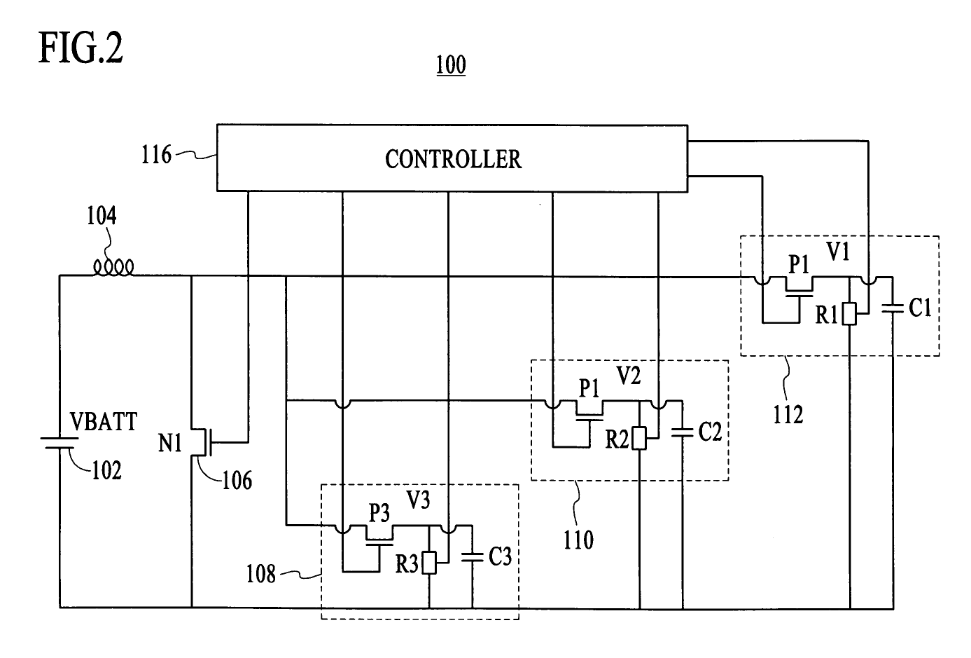

FIG. 2 is an example of a multiple output DC-DC converter 100 using a single inductor 104. The circuit 100 comprises a voltage source 102 coupled in series with a single inductor 104. A first transistor 106 is coupled to the inductor 104 and the voltage source 102. There are three switch capacitor mechanisms 108, 110 and 112 which provide three different power supplies v3, v2 and v1, respectively. Each switch capacitor mechanism 108, 110 and 112 includes a transistor coupled to a switch capacitor and the first transistor 106 all of which are controlled by the controller 116. The power supplies v1, v2 and v3 provide the necessary information for the controller 116.

The voltage source (Vbatt) is converted to 3 different power supplies v1, v2 and v3 utilizing a single inductor. R1, R2, R3 are the loads of v1, v2 and v3 respectively. A single inductor L is used to provide current to c1, c2 and c3 alternately.

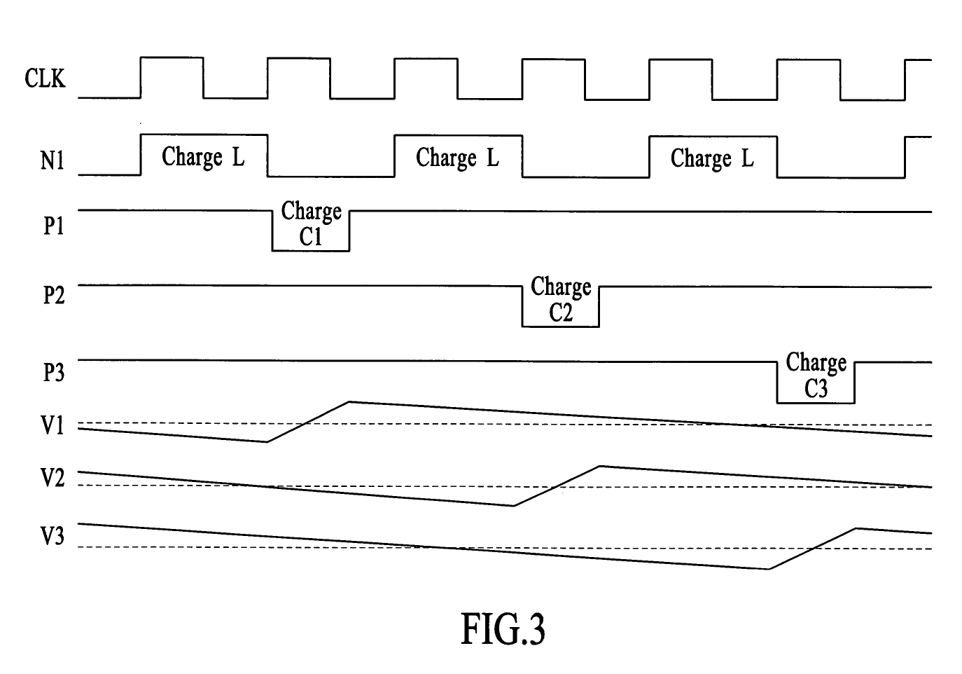

FIG. 3 shows an example operation sequence of the DC-DC converter 100. The circuit 100 has two phases when providing current to the loads. During the first phase, switch N1 is on, and switch P1, P2 and P3 are off, the inductor is charged. During the second phase, switch N1 will be off, and one of the switches, e.g., P1 will be on, hence, capacitor c1 is charged. By turning on switch P1, P2 or P3 during the second phase of each cycle alternately, c1, c2, or c3 will be charged, hence current is provided to the loads.

Control signals P1, P2, P3 and N1 are generated synchronously or asynchronously based on certain conditions. The power supply voltage of v1, v2 and v3 are monitored constantly. When the voltage is below the predetermined voltage level, charging request will be asserted. Whenever there is charging request, DC-DC converter will start charging the inductor, and then charging the power supply, whose charging request is granted. P1, P2 or P3 has to be turned off to prevent the current flow backward from capacitor to Vbatt.

Accordingly, a DC-DC converter is disclosed that allows for multiple power supplies to be provided utilizing a single inductor. In so doing the overall costs for such a converter are significantly reduced.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A DC-DC converter comprising:
a voltage source;
a single inductor coupled to the voltage source;
a first switch coupled to the single inductor and the voltage source;
a plurality of capacitor switch mechanisms, each of the plurality of capacitor switch mechanisms coupled to each other and coupled to the voltage source, first switch and the single inductor; and
a controller coupled to each of the plurality capacitor switch mechanisms, the voltage source, the first switch and the single inductor.

2. The converter of claim 1 wherein there are two phases of operation of the converter, during first phase the first switch is on and the plurality of capacitor switch mechanisms are inactive to charge the inductor; and during a second phase one of the capacitor switch mechanisms is active causing the capacitor switch mechanism to act as a power supply at a particular voltage level, wherein each of the capacitor switch mechanisms can be active alternately to provide a plurality of voltage levels.

3. The converter of claim 1 wherein signals are utilized to control the plurality of capacitor switch mechanisms to provide the appropriate voltage levels.

4. The converter of claim 3 wherein the plurality of voltage levels are monitored.

5. The converter of claim 1 wherein a charging request will be asserted when an output voltage is below a predetermined level.

6. A method for use with a converter that includes a single inductor; the method comprising:
providing two phases of operation of the converter, during a first phase a first switch is on and a plurality of capacitor switch mechanisms are inactive to charge the inductor; and during a second phase one of the capacitor switch mechanisms is active causing the capacitor switch mechanism to act as a power supply at a particular voltage level, wherein each of the capacitor switch mechanisms can be active alternately to provide a plurality of voltage levels.

7. The method of claim 6 wherein signals are utilized to control the plurality of capacitor switch mechanisms to provide the appropriate voltage level

8. The method of claim 6 wherein the plurality of voltage levels are monitored.

9. The method of claim 8 wherein a charging request will be asserted when an output voltage is below a predetermined level.
